(19) United States
(12) Patent Application Publication
(10) Pub. No.: US 2011/0305944 A1
(43) Pub. Date: Dec. 15, 2011

(54) Electrode Assembly and Rechargeable Battery Using Same

(75) Inventors: Na-Ri Seo, Yongin-si (KR); Ki-Jun Kim, Yongin-si (KR); Ihn Kim, Yongin-si (KR); Sam-Jin Park, Yongin-si (KR); Seung-Hun Han, Yongin-si (KR); Hye-Sun Jeong, Yongin-si (KR)

(73) Assignee: SAMSUNG SDI CO., LTD., Yongin-si (KR)

(21) Appl. No.: 12/952,350

(22) Filed: Nov. 23, 2010

(30) Foreign Application Priority Data
Jun. 10, 2010 (KR) 10-2010-0054973

(51) Int. Cl. H01M 4/70; H01M 2/30

(52) U.S. Cl. 429/179; 429/233

(57) ABSTRACT

An electrode assembly according to an exemplary embodiment of the present invention comprises: a first electrode which includes a first electrode current collector and a first electrode active material layer formed on the first electrode current collector; a second electrode which includes a second electrode current collector and a second electrode active material layer formed on the second electrode current collector; and a separator disposed between the first electrode and the second electrode. A supporting portion is formed of a groove or a protrusion at an edge of the first electrode current collector, and a combination portion is combined with the supporting portion on the first electrode active material layer.

### CLAIM OF PRIORITY

This application makes reference to, incorporates the same herein, and claims all benefits accruing under 35 U.S.C. §119 from an application for earlier filed in the Korean Intellectual Property Office on Jun. 10, 2010 and there duly assigned Serial No. 10-2010-0054973.

### BACKGROUND OF THE INVENTION

1. Field of the Invention

The present invention relates to an electrode assembly and a rechargeable battery and, more particularly, to an electrode assembly and a rechargeable battery in which a combination structure of a current collector and an active material layer is improved.

2. Description of the Related Art

A rechargeable battery is a battery which is capable of performing charging and discharging, unlike a primary battery which is not capable of performing charging. A rechargeable battery which has a low capacity is used in a small electronic device such as a mobile phone, a laptop computer and a camcorder, and a large capacity battery is widely used as power for motor driving in a hybrid vehicle and the like.

Recently, a large capacity high power rechargeable battery which includes a non-aqueous electrolyte having a high energy density has been developed, and is constituted by a high power battery module in which a plurality of rechargeable batteries are coupled in series in order to use it to drive devices storing power or requiring large power.

In addition, the rechargeable battery may be cylindrical, angular, or pouch type.

The rechargeable battery includes a positive electrode and a negative electrode, and a separator which is disposed between the positive electrode and the negative electrode. The positive electrode and negative electrode include a current collector which is made of metal thin film, and an active material layer which is formed on the current collector. In general, an active material layer is attached to the current collector by coating, and if the active material layer deviates from the current collector or an interval between the active material layer and current collector is increased because the active material layer is stably attached to the current collector, charging and discharge efficiency is deteriorated. Particularly, while charging and discharging are repeated, an electrode is expanded and, in this process, there is a problem in that the active material layer and the current collector which have different expansion ratios are separated from each other.

The above information disclosed in this Background section is only for enhancement of an understanding of the background of the invention, and therefore it may contain information which does not form the prior art which is already known in this country to a person of ordinary skill in the art.

### SUMMARY OF THE INVENTION

The present invention has been developed in an effort to provide an electrode assembly and a rechargeable battery in which a current collector and an active material layer can be stably combined with each other.

An exemplary embodiment of the present invention provides an electrode assembly, comprising: a first electrode which includes a first electrode current collector and a first electrode active material layer which is formed on the first electrode current collector; a second electrode which includes a second electrode current collector and a second electrode active material layer which is formed on the second electrode current collector; and a separator which is disposed between the first electrode and the second electrode; wherein a supporting portion is formed of a groove or a protrusion at an edge of the first electrode current collector, and a combination portion is combined with the supporting portion on the first electrode active material layer.

The supporting portion may be formed along the edge of the first electrode current collector, and the first electrode current collector may include an attachment area to which the first electrode active material layer is attached, and a non-attachment area to which the first electrode active material layer is not attached.

The supporting portion may be formed along the edge of the attachment area, a flat portion in which the supporting portion is not formed is formed in the supporting portion, and the supporting portion may be formed at the corner portion of the attachment area.

The edge portion, in which a plurality of supporting portions are formed at the edge of the attachment area, may be formed, and a flat portion which has a smaller average surface step than the edge portion may be formed in the edge portion. The average surface step of the edge portion may be 5 to 60 times the average surface step of the flat portion, the average surface step of the flat portion may be 0.1 to 1 μm and the average surface step of the edge portion may be 5 to 6 μm.

The supporting portion may be formed of a groove and the combination portion may be formed of a protrusion, the lateral surface of the groove may be formed in an inclined manner so as to become distant from the center of the groove as it goes toward the bottom of the groove, and the lateral surface of the protrusion may be formed in an inclined manner so as to become distant from the center of the protrusion as it goes toward the protruding end of the protrusion. In addition, the groove may have an inlet area which is smaller than a bottom area, and the protrusion may have an area of an upper portion which protrudes and is larger than an area of a lower portion.

The supporting portion may be formed of a protrusion and the combination portion may be formed of a groove, the lateral surface of the protrusion may be formed in an inclined manner so as to become distant from the center of the protrusion as it goes toward the protruding end of the protrusion, and the lateral surface of the groove may be formed in an inclined manner so as to become distant from the center of the groove as it goes toward the bottom of the groove. In addition, the protrusion may have an area of an upper portion which is larger than an area of a lower portion, and the groove may have an inlet area which is smaller than a bottom area.

Meanwhile, the supporting portion which is formed of the groove or protrusion may be formed at the edge of the second electrode current collector, and the first electrode active material layer may be combined with the supporting portion.

Another exemplary embodiment of the present invention provides an electrode assembly, comprising: a first electrode which includes a first electrode current collector and a first electrode active material layer which is formed on the first electrode current collector; a second electrode which includes a second electrode current collector and a second electrode active material layer which is formed on the second electrode current collector; and a separator which is disposed between the first electrode and the second electrode; wherein the edge portion is formed at the edge of the first electrode current collector, the flat portion is formed in the edge portion, and the edge portion has a larger average surface step than the flat portion.

Yet another exemplary embodiment of the present invention provides a rechargeable battery, comprising: an electrode assembly which includes a first electrode, a second electrode and a separator which is disposed between the first electrode and the second electrode; a case in which the electrode assembly is mounted; and a terminal which is electrically connected to the electrode assembly, and which is exposed to an external side of the case; wherein the first electrode includes the first electrode current collector and the first electrode active material layer which is formed on the first electrode current collector, the supporting portion which is formed of the groove or protrusion is formed at the edge of the first electrode current collector, and the combination portion which is combined with the supporting portion is formed on the first electrode active material layer.

The supporting portion may be formed along the edge of the first electrode current collector, and the first electrode current collector may include an attachment area to which the first electrode active material layer is attached and a non-attachment area to which the first electrode active material layer is not attached.

The supporting portion may be formed along the edge of the attachment area, the flat portion in which the groove is not formed may be formed in the groove, and the supporting portion may be formed at the corner portion of the non-attachment area.

In addition, the edge portion in which a plurality of supporting portions are formed at the edge of the attachment area may be formed, a flat portion which has a smaller average surface step than the edge portion may be formed in the edge portion, the average surface step of the edge portion may be 5 to 60 times of the average surface step of the flat portion, the average surface step of the flat portion may be 0.1 to 1 μm and the average surface step of the edge portion may be 5 to 6 μm.

The supporting portion may be formed of a groove and the combination portion may be formed of a protrusion which is inserted into the groove, the lateral surface of the groove may be formed in an inclined manner so as to become distant from the center of the groove as it goes toward the bottom of the groove, and the lateral surface of the protrusion may be formed in an inclined manner so as to become distant from the center of the protrusion as it goes toward the protruding end of the protrusion. In addition, the groove may have an inlet area which is smaller than a bottom area, and the protrusion may have an area of an upper portion which is larger than an area of a lower portion.

The supporting portion may be formed of a protrusion and the combination portion is formed of a groove, the lateral surface of the protrusion may be formed in an inclined manner so as to become distant from the center of the protrusion as it goes toward the protruding end of the protrusion, and the lateral surface of the groove may be formed in an inclined manner so as to become distant from the center of the groove as it goes toward the bottom of the groove. In addition, the protrusion may have an area of an upper portion which is larger than an area of a lower portion, and the groove may have an inlet area which is smaller than a bottom area.

Meanwhile, the second electrode may include the second electrode current collector and the second electrode active material layer which is formed on the second electrode current collector, the supporting portion which is formed of the groove or protrusion may be formed at the edge of the second electrode current collector, and the combination portion which is combined with the supporting portion may be formed on the first electrode active material layer.

Still another exemplary embodiment of the present invention provides a rechargeable battery, comprising: an electrode assembly which includes a first electrode, a second electrode and a separator which is disposed between the first electrode and the second electrode; a case in which the electrode assembly is mounted; and a terminal which is electrically connected to the electrode assembly, and which is exposed to an external side of the case; wherein the first electrode includes the first electrode current collector and the first electrode active material layer which is formed on the first electrode current collector, the edge portion is formed at the edge of the first electrode current collector, the flat portion is formed in the edge portion, and the edge portion has a larger average surface step than the flat portion.

According to the exemplary embodiments of the present invention, it is possible to prevent an active material layer and a current collector from being separated from each other by stably combining the active material layer and the current collector. Accordingly, charging and discharging efficiencies of the electrode assembly and rechargeable battery are improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view which illustrates a rechargeable battery according to a first exemplary embodiment of the present invention;

FIG. 2 is a cross-sectional view taken along the line II-II of FIG. 1;

FIG. 3 is a perspective view which illustrates an electrode assembly according to a first exemplary embodiment of the present invention;

FIG. 4 is an exploded perspective view which illustrates a first electrode according to a first exemplary embodiment of the present invention;

FIG. 5 is a cross-sectional view taken in a state in which members shown in FIG. 4 are combined with each other;

FIG. 6 is a cross-sectional view of the second electrode of a rechargeable battery according to a first exemplary embodiment of the present invention;

FIG. 7 is a cross-sectional view of the first electrode of a rechargeable battery according to a second exemplary embodiment of the present invention;

FIG. 8 is a cross-sectional view of the first electrode of a rechargeable battery according to a third exemplary embodiment of the present invention;

FIG. 9 is a cross-sectional view of the first electrode of a rechargeable battery according to a fourth exemplary embodiment of the present invention;

FIG. 10 is an exploded perspective view of the first electrode of a rechargeable battery according to a fifth exemplary embodiment of the present invention;

FIG. 11 is a cross-sectional view of the first electrode taken in a state in which members shown in FIG. 10 are combined with each other; and

FIG. 12 is an exploded perspective view of the first electrode of a rechargeable battery according to a sixth exemplary embodiment of the present invention.

### DETAILED DESCRIPTION OF THE INVENTION

Hereinafter, the present invention will be described more fully hereinafter with reference to the accompanying drawings, in which exemplary embodiments of the invention are shown. As those skilled in the art will realize, the described embodiments may be modified in various different ways, all without departing from the spirit or scope of the present invention. In the drawings and description, like reference numerals designate like elements throughout the specification.

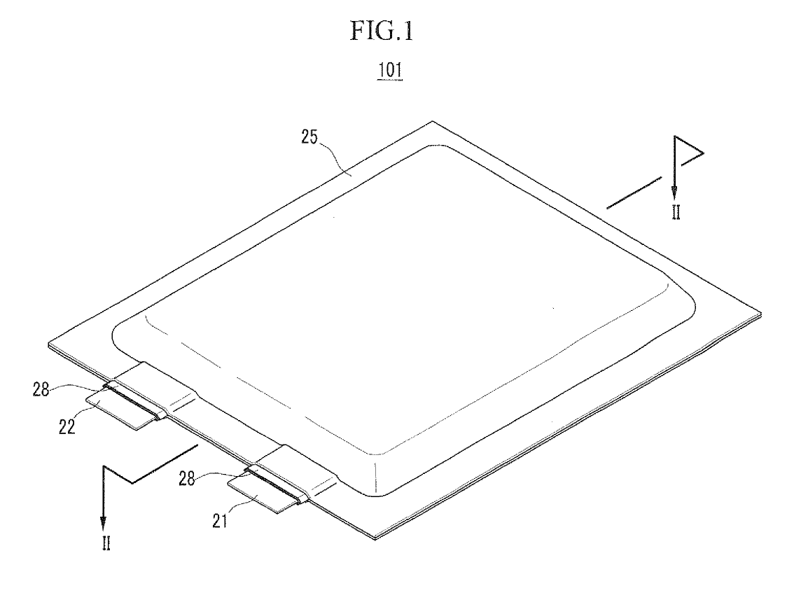

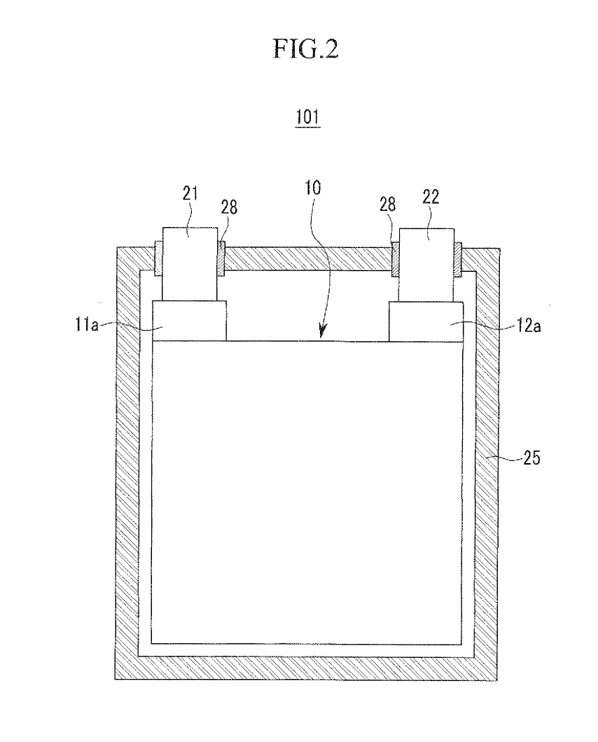

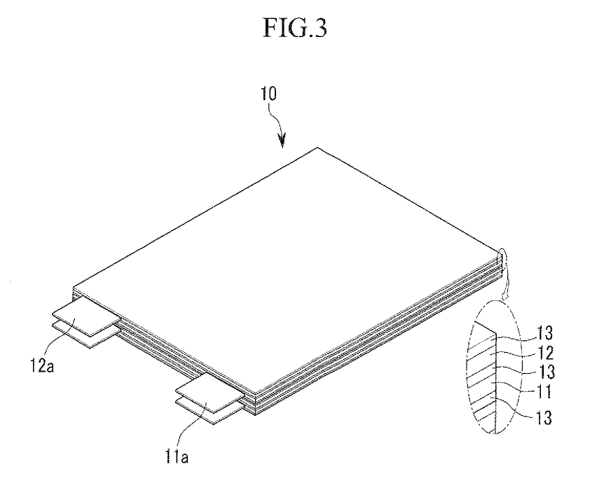

FIG. 1 is a perspective view which illustrates a rechargeable battery according to a first exemplary embodiment of the present invention, FIG. 2 is a cross-sectional view taken along the line II-II of FIG. 1, and FIG. 3 is a perspective view which illustrates an electrode assembly according to a first exemplary embodiment of the present invention.

Referring to FIG. 1 and FIG. 2, the rechargeable battery 101 includes an electrode assembly 10 which performs charging and discharging and a case 25 in which an electrode assembly 10 is mounted.

The case 25 forms an entire appearance of the rechargeable battery 101, and provides a space in which the electrode assembly 10 is mounted. The case 25 is a pouch type case to which the film is attached. However, the present invention is not limited thereto, and the case 25 may be formed of various shapes, such as cylindrical or angular shapes.

The first terminal 21 and the second terminal 22 are electrically connected to the electrode assembly 10, and the first terminal 21 and the second terminal 22 protrude to the outside of the case 25.

The first terminal 21 and the second terminal 22 protrude to the outside of the case 25, and the insulation layer 28 for insulation and sealing is disposed between the first terminal 21 and the second terminal 22, on one side, and the case 25, on the other side. The first terminal 21 and the second terminal 22 according to the exemplary embodiment protrude in the same direction as the case 25, but the present invention is not limited thereto, and the first terminal 21 and the second terminal 22 may protrude in an opposite direction.

As shown in FIG. 2 and FIG. 3, the electrode assembly 10 includes the first electrode 11, the second electrode 12, and the separator 13 disposed between the first electrode 11 and the second electrode 12. The electrode assembly 10 has a structure in which a plurality of the first electrodes 11 and second electrodes 12 having a sheet shape are alternately layered with the separator 13 which is disposed therebetween. However, the present invention is not limited thereto, and it may have a spiral-wound structure in which the first electrode 11 and second electrode 12 having a band shape are disposed with the separator 13 being disposed therebetween.

The separator 13 is formed of a porous sheet, insulates the first electrode 11 and the second electrode 12, and provides a path through which electrons move. The separator 13 may be formed of a single or complex polyolefine film, such as polyethylene or polypropylene, manila paper, and the like.

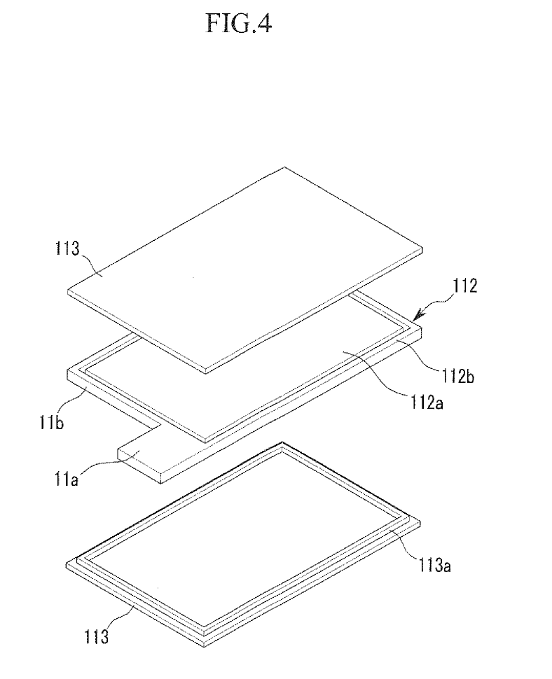

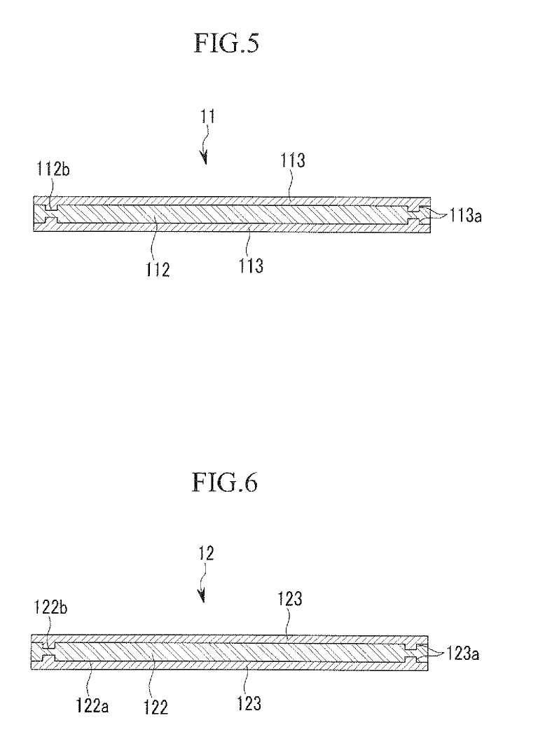

FIG. 4 is an exploded perspective view which illustrates a first electrode according to a first exemplary embodiment of the present invention, FIG. 5 is a cross-sectional view taken in a state in which members shown in FIG. 4 are combined with each other, and FIG. 6 is a cross-sectional view of the second electrode of a rechargeable battery according to a first exemplary embodiment of the present invention.

As seen in FIG. 4, the first electrode 11 includes the first electrode current collector 112 and the first electrode active material layer 113, which is attached to both sides of the first electrode current collector 112. The first electrode active material layer 113 is coated or laminated on the first electrode current collector 112, and is thus attached thereto.

The first electrode current collector 112 is formed in the shape of a rectangular sheet, and is made of materials such as aluminum, stainless steel and the like.

The first electrode active material layer 113 is formed of LiCoO₂, LiMnO₂, LiFePO₄, LiNiO₂, LiMn₂O₄, or carbon-based active material, tertiary active material and the like, a conductive agent, a binder and the like. The first electrode active material layer 113 is not formed on the upper portion of the first electrode current collector 112, and the first electrode non-attachment area 11a, in which the first electrode current collector 112 is exposed, is formed. The first terminal 21 is attached to the first electrode non-attachment area 11a by welding and the like.

In the exemplary embodiment, an example in which the first electrode 11 is a positive electrode and the second electrode 12 is a negative electrode is described. However, the present invention is not limited thereto, and the first electrode 11 may be a negative electrode, and the second electrode 12 may be a positive electrode.

As shown in FIG. 6, the second electrode 12 includes the second electrode current collector 122 and the second electrode active material layer 123 which is attached to both sides of the second electrode current collector 122.

The second electrode current collector 122 is formed of a material such as copper, stainless steel or aluminum, and the second electrode active material layer 123 is formed of Li4Ti5O12 or carbon-based active material, a conductive agent, a binder and the like. The second electrode active material layer 123 is not formed on the upper portion of the second electrode 12, and the first electrode non-attachment area 12a in which the second electrode current collector 122 is exposed is formed.

Further referring to FIG. 4 and FIG. 5, in the first electrode current collector 112, the attachment area 11b to which the first electrode active material layer 113 is attached, and the non-attachment area 11a to which the first electrode active material layer 113 is not attached, are formed. The attachment area 11b is formed in a quadrangle shape, and the non-attachment area 11a protrudes from the upper portion of the attachment area 11b.

The supporting portion, which is formed of the groove 112b, is formed at the edge of the first electrode current collector 112, the groove 112b is formed along the edge of the first electrode current collector 112, and the flat portion 112a in which the groove 112b is not formed is formed in the groove 112b. The groove 112b is formed at the edge of the attachment area 11b in the first electrode current collector 112. The flat portion 112a is formed of a rectangular area which has a flat surface, and the groove 112b is formed of a rectangular cycle shape which surrounds the circumference of the flat portion 112a. The flat portion 112a and the groove 112b are formed on both sides of the first electrode current collector 112.

The first electrode active material layer 113 is attached to both sides of the first electrode current collector 112, and a combination portion which is formed of the protrusion 113a which is combined with the groove 112b is formed on the first electrode active material layer 113. The protrusion 113a is formed along the edge of the first electrode active material layer 113 and is inserted into the groove 112b.

Like the exemplary embodiment, the supporting portion which is formed of the groove 112b is formed at the edge of the first electrode current collector 112, the combination portion which is inserted into the supporting portion and is formed of the protrusion 113a is formed on the first electrode active material layer 113, such that it is possible to prevent the deviation of the first electrode active material layer 113 from the first electrode current collector 112 by the combination of the groove 112b and the protrusion 113a. Particularly, in the case wherein the first electrode current collector 112 and the first electrode active material layer 113 are expanded while the charging and the discharging are repeated, since the first electrode active material layer 113 and the groove 112b are expanded together, the first electrode active material layer 113 is more stably attached to the first electrode current collector 112. Particularly, since the groove 112b is formed at the edge of the first electrode current collector 112, it is possible to stably prevent the deviation of the first electrode active material layer 113 from the edge thereof.

Referring to FIG. 6, in the view of the second electrode 12, the supporting portion formed of the groove 122b is formed on the second electrode current collector 122, and a union portion formed of the protrusion 123a which is inserted into the groove 122b is formed on the second electrode active material layer 123. In addition, the flat portion 112a (FIG. 4) on which the groove 112b is not formed is formed in the groove 112b, and the groove 112b is formed along the external side of the flat portion 112a. Since the second electrode 12 has the same structure as the first electrode 11, a detailed description of the second electrode 12 will be omitted.

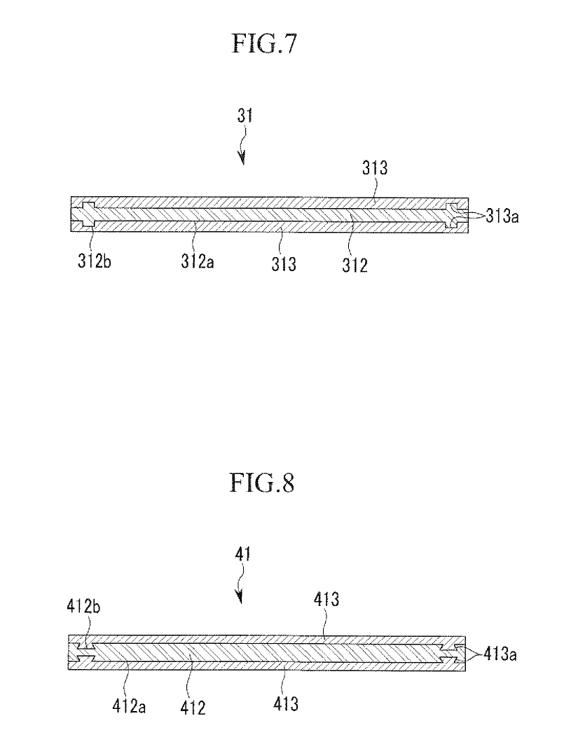

FIG. 7 is a cross-sectional view of the first electrode of a rechargeable battery according to a second exemplary embodiment of the present invention.

Referring to FIG. 7, since the rechargeable battery according to the exemplary embodiment is constituted by the same structure as the rechargeable battery according to the first exemplary embodiment with the exception of the structure of the first electrode 31, a description of the same structure will be omitted.

The first electrode 31 includes the first electrode current collector 312 and the first electrode active material layer 313 which is attached to the first electrode current collector 312, and the supporting portion formed of the protrusion 312b is formed at the edge of the first electrode current collector 312. The protrusion 312b is formed along the edge of the area in which the first electrode active material layer 313 is attached in the first electrode current collector 312, and the flat portion 312a in which the protrusion 312b is not formed is formed in the protrusion 312b.

Meanwhile, the combination portion formed of the groove 313a into which the protrusion 312b is inserted is formed in the first electrode active material layer 313, and the protrusion 312b is inserted into the groove 313a such that the first electrode current collector 312 and the first electrode active material layer 313 are combined with each other. Like the exemplary embodiment, if the protrusion 312b formed on the first electrode current collector 312 is inserted into the groove 313a which is formed in the first electrode active material layer 313, it is possible to prevent the deviation of the first electrode active material layer 313 from the first electrode current collector 312.

FIG. 8 is a cross-sectional view of the first electrode of a rechargeable battery according to a third exemplary embodiment of the present invention.

Referring to FIG. 8, since the rechargeable battery according to the exemplary embodiment is constituted by the same structure as the rechargeable battery according to the first exemplary embodiment with the exception of the structure of the first electrode 41, a description of the same structure will be omitted.

The first electrode 41 includes the first electrode current collector 412 and the first electrode active material layer 413 attached to the first electrode current collector 412, and the groove 412b is formed at the edge of the first electrode current collector 412. The groove 412b is formed along the edge of the area in which the first electrode active material layer 413 is attached in the first electrode current collector 412, and the flat portion 412a in which the groove 412b is not formed is formed in the groove 412b. The groove 412b has an inlet formed on the upper portion of the groove 412b and a bottom formed on the lower portion which faces the inlet, and the area of the inlet of the groove 412b is smaller than the area of the bottom.

Meanwhile, the protrusion 413a which is inserted into the groove 412b is formed on the first electrode active material layer 413, and the area of the upper portion of the protrusion 413a is larger than the area of the lower portion thereof. In addition, the protrusion 413a and the groove 412b are combined with each other, and the area of the upper portion of the protrusion 413a is larger than the area of the inlet of the groove 412b.

Like the exemplary embodiment, the area of the inlet of the groove 412b is smaller than the area of the bottom, and if the area of the upper portion of the protrusion 413a which is inserted thereinto is larger than the area of the lower portion, the protrusion 413a cannot be easily deviated from the groove 412b, such that the first electrode active material layer 413 is more stably fixed to the first electrode current collector 412.

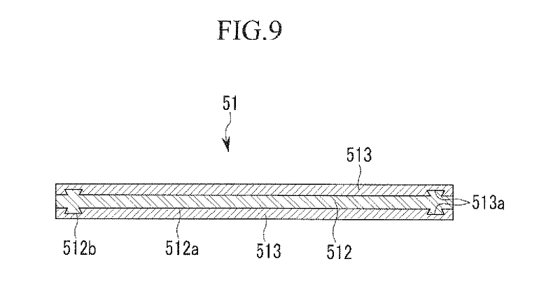

FIG. 9 is a cross-sectional view of the first electrode of a rechargeable battery according to a fourth exemplary embodiment of the present invention.

Referring to FIG. 9, since the rechargeable battery according to the exemplary embodiment is constituted by the same structure as the rechargeable battery according to the first exemplary embodiment with the exception of the structure of the first electrode 51, a description of the same structure will be omitted.

The first electrode 51 includes the first electrode current collector 512 and the first electrode active material layer 513 attached to the first electrode current collector 512, and the protrusion 512b is formed at the edge of the first electrode current collector 512. The protrusion 512b is formed along the edge of the area in which the first electrode active material layer 513 is attached in the first electrode current collector 512, and the flat portion 512a in which the protrusion 512b is not formed is formed in the protrusion 512b. The lateral surface of the protrusion 512b is formed in an inclined manner, and the lateral surface of the protrusion becomes further from the center of the protrusion 512b as it goes to the protruding end of the protrusion 512b. Accordingly, the area of the upper portion of the protrusion 512b is larger than the area of the lower portion thereof which is connected to the upper portion of the first electrode current collector 512.

Meanwhile, the groove 513a into which the protrusion 512b is inserted is formed in the first electrode active material layer 513, and the lateral surface of the groove 513a is formed in an inclined manner so that it becomes further from the center of the groove 513a as it goes to the bottom of the groove 513a. Therefore, the area of the bottom of the groove 513a is larger than the area of the inlet thereof. In addition, the protrusion 512b and the groove 513a are combined with each other, and the area of the upper portion of the protrusion 512b is larger than the area of the inlet of the groove 513a.

Like the exemplary embodiment, the area of the upper portion of the protrusion 512b is smaller than the area of the lower portion, and if the area of the inlet of the groove 513a into which it is inserted is larger than the area of the bottom, the protrusion cannot be easily deviated from the groove, such that the first electrode active material layer is more stably fixed to the first electrode current collector.

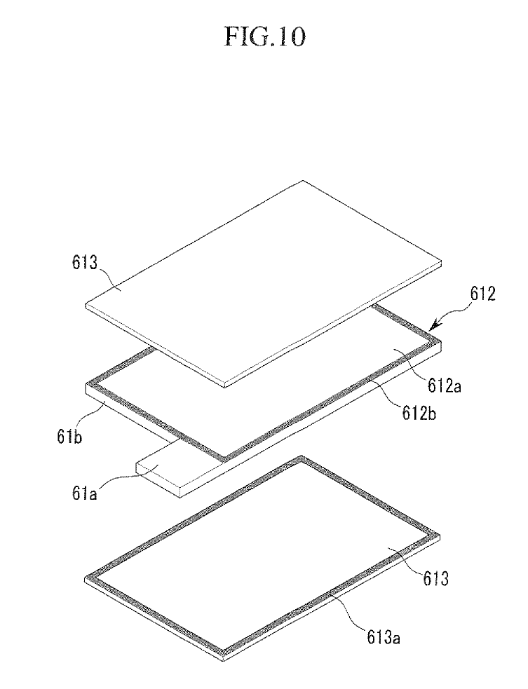

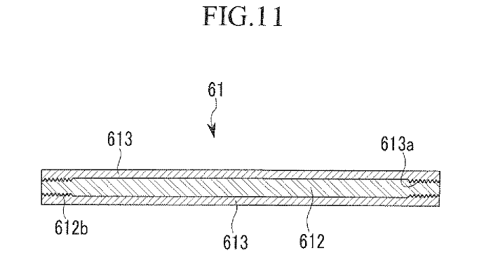

FIG. 10 is an exploded perspective view of the first electrode of a rechargeable battery according to a fifth exemplary embodiment of the present invention, and FIG. 11 is a cross-sectional view of the first electrode taken in a state in which members shown in FIG. 10 are combined with each other.

Referring to FIG. 10 and FIG. 11, since the rechargeable battery according to the exemplary embodiment is constituted by the same structure as the rechargeable battery according to the first exemplary embodiment with the exception of the structure of the first electrode 61, a description of the same structure will be omitted.

The first electrode 61 includes the first electrode current collector 612 and the first electrode active material layer 613 attached on the first electrode current collector 612.

In the first electrode current collector 612, the attachment area 61b to which the first electrode active material layer 613 is attached, and the non-attachment area 61a to which the first electrode active material layer 613 is not attached, are formed. The attachment area 61b is formed in a quadrangle shape, and the non-attachment area 61a protrudes from the upper portion of the attachment area.

The edge portion 612b, in which a plurality of grooves are formed, is formed at the edge of the first electrode current collector 612. The grooves may be formed while they are connected to each other, or a plurality of grooves may be formed while being separated from each other.

The edge portions 612b are formed along the edge of the first electrode current collector 612 while they are connected to each other, and the flat portion 612a which has the smaller surface step than the edge portion 612b is formed in the edge portion 612b. The average surface step (Er) of the edge portion 612b is 5 to 60 times the average surface step (Fr) of the flat portion. The average surface step (Er) of the edge portion 612b is 5 to 6 μm, and the average surface step (Fr) of the flat portion 612a may be 0.1 to 1 μm. Here, the average surface step means the average of the height of the protrusion and depression that are formed on the surface thereof.

The edge portion 612b is formed at the edge of the attachment area in the first electrode current collector 612. The flat portion 612a is formed of a rectangular area which has a flat surface, and the edge portion 612b is formed of a rectangular cycle shape which surrounds the circumference of the flat portion. The protrusion 613a, which is in contact with the edge portion 612b, is formed in the first electrode active material layer 613 which is in contact with the edge portion 612b.

Like the exemplary embodiment, if the edge portion 612b which has the larger surface step than the flat portion 612a is formed in the first electrode current collector 612, it is possible to prevent the deviation of the first electrode active material layer 613 from the first electrode current collector 612 by supporting the first electrode active material layer 613 in the edge portion 612b.

Particularly, it is possible to prevent an increase in resistance because the uneven protrusions and depressions are formed on the entire first electrode current collector 612 by forming the edge portion 612b on only the edge of the first electrode current collector 612.

TABLE 1

| | First time | Second time | Third time |
|---|---|---|---|
| Comparative Example | 4.090*10⁻⁶ O | 4.078*10⁻⁶ O | 4.086*10⁻⁶ O |
| Exemplary | 2.739*10⁻⁶ O | 2.809*10⁻⁶ O | 2.734*10⁻⁶ O |
| embodiment | | | |

Table 1 shows measurement of specific resistance after scratches are formed on the surface of an aluminum thin plate. An aluminum thin plate having a width and a length of 8 mm, and a thickness of 30 μm, was used.

The exemplary embodiment forms the scratches only at both edges of the aluminum thin plate, and the Comparative Example forms the scratches on the entire surface of both sides of the aluminum thin plate. After the scratches were formed on the aluminum thin plate one to three times, each specific resistance was measured. As shown in Table 1, the specific resistance of the exemplary embodiment was smaller than the specific resistance of the Comparative Example by 70%, and the specific resistance was not greatly changed according to the number of scratches. The reason why there is a difference between the specific resistances is that the surface area of the aluminum thin film is increased by the scratches and a moving distance of a current is increased.

When an aluminum thin plate having a very small size was used as the sample, the specific resistance was relatively small, but when an aluminum thin plate having a large size was used, the specific resistance was relatively large. As described above, if the specific resistance is increased, there are problems in that charging and discharging efficiencies are deteriorated, and since a large amount of heat is generated, the life-span of the rechargeable battery is lowered. However, as shown in the exemplary embodiment, if the scratches are formed at only the edge portion thereof, while the specific resistance is not increased, the first electrode active material layer can be stably fixed to the first electrode current collector.

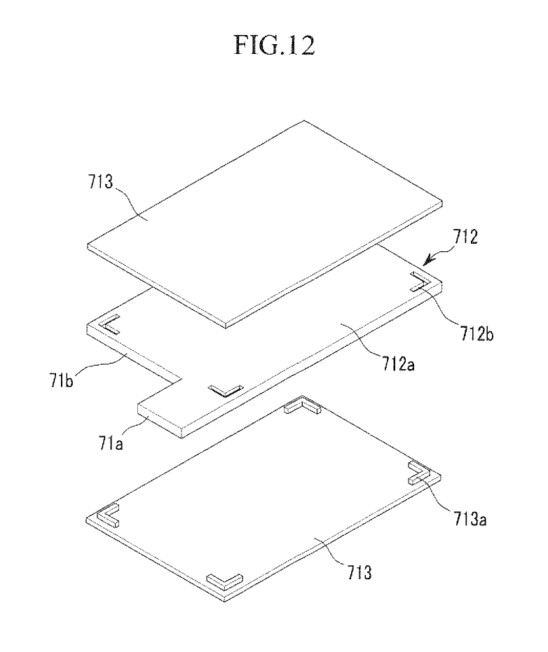

FIG. 12 is an exploded perspective view of the first electrode of a rechargeable battery according to a sixth exemplary embodiment of the present invention.

Referring to FIG. 12, since the rechargeable battery according to the exemplary embodiment is constituted by the same structure as the rechargeable battery according to the first exemplary embodiment with the exception of the structure of the first electrode 71, a description of the same structure will be omitted.

In the first electrode current collector 712, the attachment area 71b to which the first electrode active material layer 713 is attached, and the non-attachment area 71a to which the first electrode active material layer 713 is not attached, are formed. The attachment area 71b is formed in a quadrangle shape, and the non-attachment area 71a protrudes from the upper portion of the attachment area.

The groove 712b is formed at the edge of the first electrode current collector 712, and the groove 712b is formed at a corner portion of the first electrode current collector 712. The first electrode current collector 712 has an almost rectangular sheet shape, and the groove 712b is formed at four corners of the first electrode current collector 712. The flat portion 712a, in which the groove 712b is not formed, is formed in the groove 712b.

The groove 712b is formed at corners of the attachment area 71b in the first electrode current collector 712, and the groove 712b has approximately an L shape. The flat portion 712a is formed of a rectangular area which has a flat surface, and the groove 712b and flat portion 712a are formed on both sides of the first electrode current collector 712.

The first electrode active material layer 713 is attached to both sides of the first electrode current collector 712, and the protrusion 713a which is inserted into the groove 712b is formed on the first electrode active material layer 713. The protrusion 713a has an L shape, and is formed at the corners of the first electrode active material layer 713, thus being inserted into the groove 712b.

Like the exemplary embodiment, the groove 712b is formed at the edge of the first electrode current collector 712, and if the protrusion 713a is formed on the first electrode active material layer 713, it is possible to prevent the deviation of the first electrode active material layer 713 from the first electrode current collector 712 by the combination of the groove 712b and the protrusion 713a.

While this invention has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

What is claimed is:

1. An electrode assembly, comprising:
a first electrode which includes a first electrode current collector and a first electrode active material layer formed on the first electrode current collector;
a second electrode which includes a second electrode current collector and a second electrode active material layer formed on the second electrode current collector; and
a separator disposed between the first electrode and the second electrode;
wherein a supporting portion is formed of one of a groove and a protrusion at an edge of the first electrode current collector, and a combination portion is combined with the supporting portion on the first electrode active material layer.

2. The electrode assembly of claim 1, wherein the first electrode current collector includes an attachment area to which the first electrode active material layer is attached and a non-attachment area to which the first electrode active material layer is not attached.

3. The electrode assembly of claim 2, wherein the supporting portion is formed along an edge of the attachment area, and a flat portion in which the supporting portion is not formed is formed in the supporting portion.

4. The electrode assembly of claim 2, wherein the supporting portion is formed at a corner portion of the attachment area.

5. The electrode assembly of claim 2, wherein an edge portion in which a plurality of supporting portions are formed at the edge of the attachment area is formed, and a flat portion having an average surface step smaller than an average surface step of the edge portion is formed in the edge portion.

6. The electrode assembly of claim 5, wherein the average surface step of the edge portion is 5 to 60 times the average surface step of the flat portion.

7. The electrode assembly of claim 6, wherein the average surface step of the flat portion is 0.1 to 1 μm and the average surface step of the edge portion is 5 to 6 p.m.

8. The electrode assembly of claim 1, wherein the supporting portion is formed of a groove and the combination portion is formed of a protrusion.

9. The electrode assembly of claim 8, wherein the groove has an inlet area smaller than a bottom area, and the protrusion has an area of an upper portion which protrudes and which is larger than an area of a lower portion.

10. The electrode assembly of claim 1, wherein the supporting portion is formed of a protrusion and the combination portion is formed of a groove.

11. The electrode assembly of claim 10, wherein the protrusion has an area of an upper portion which is larger than an area of a lower portion, and the groove has an inlet area which is smaller than a bottom area.

12. The electrode assembly of claim 1, wherein the supporting portion, which is formed of one of a groove and a protrusion, is formed at an edge of the second electrode current collector, and the combination portion is combined with the supporting portion of the second electrode current collector and is formed in the second electrode active material layer.

13. An electrode assembly, comprising:
a first electrode which includes a first electrode current collector and a first electrode active material layer formed on the first electrode current collector;
a second electrode which includes a second electrode current collector and a second electrode active material layer formed on the second electrode current collector; and
a separator disposed between the first electrode and the second electrode;
wherein an edge portion is formed at an edge of the first electrode current collector, a flat portion is formed in the edge portion, and the edge portion has an average surface step larger than an average surface step of the flat portion.

14. A rechargeable battery, comprising:
an electrode assembly which includes a first electrode, a second electrode and a separator disposed between the first electrode and the second electrode;
a case in which the electrode assembly is mounted; and
a terminal electrically connected to the electrode assembly and exposed to an external side of the case;
wherein the first electrode includes a first electrode current collector and a first electrode active material layer formed on the first electrode current collector, a supporting portion formed of one of a groove and a protrusion is formed at an edge of the first electrode current collector, and a combination portion is combined with the supporting portion and is formed on the first electrode active material layer.

15. The rechargeable battery of claim 14, wherein the first electrode current collector includes an attachment area to which the first electrode active material layer is attached, and a non-attachment area to which the first electrode active material layer is not attached.

16. The rechargeable battery of claim 15, wherein the supporting portion is formed along an edge of the attachment area, and a flat portion in which the groove is not formed is formed in the groove.

17. The rechargeable battery of claim 15, wherein the supporting portion is formed at a corner portion of the non-attachment area.

18. The rechargeable battery of claim 15, wherein an edge portion, in which a plurality of supporting portions are formed at the edge of the attachment area, is formed, and a flat portion having an average surface step smaller than an average surface step of the edge portion is formed in the edge portion.

19. The rechargeable battery of claim 18, wherein the average surface step of the edge portion is 5 to 60 times the average surface step of the flat portion.

20. The rechargeable battery of claim 14, wherein the supporting portion is formed of a groove and the combination portion is formed of a protrusion.

21. The rechargeable battery of claim 20, wherein the groove has an inlet area which is smaller than an inlet area of a bottom area, and the protrusion has an area of an upper portion which protrudes and is larger than an area of a lower portion.

22. The rechargeable battery of claim 14, wherein the supporting portion is formed of a protrusion and the combination portion is formed of a groove.

23. The rechargeable battery of claim 22, wherein the protrusion has an area of an upper portion which is larger than an area of a lower portion, and the groove has an inlet area which is smaller than a bottom area.

24. A rechargeable battery, comprising:
an electrode assembly which includes a first electrode, a second electrode and a separator disposed between the first electrode and the second electrode;
a case in which the electrode assembly is mounted; and
a terminal electrically connected to the electrode assembly and exposed to an external side of the case;
wherein the first electrode includes a first electrode current collector and a first electrode active material layer formed on the first electrode current collector, an edge portion is formed at an edge of the first electrode current collector, a flat portion is formed in the edge portion, and the edge portion has an average surface step larger than an average surface step of the flat portion.
